(19) United States
(12) Patent Application Publication
(10) Pub. No.: US 2015/0061931 A1
(43) Pub. Date: Mar. 5, 2015

(54) METHODS AND SYSTEMS FOR PSEUDO-RANDOM CODING IN A WIDE AREA POSITIONING SYSTEM

(71) Applicant: NextNav, LLC, Sunnyvale, CA (US)

(72) Inventors: Norman F. Krasner, Redwood CIty, CA (US); Bhaskar Nallapureddy, Sunnyvale, CA (US)

(73) Assignee: NextNav, LLC, Sunnyvale, CA (US)

(21) Appl. No.: 14/011,277

(22) Filed: Aug. 27, 2013

(51) Int. Cl. G01S 19/46; H04B 1/709; H04B 1/711; G01S 5/14

(52) U.S. Cl. CPC G01S 19/46; G01S 5/145; H04B 1/709; H04B 1/711
USPC 342/357.29; 342/463; 375/146

(57) ABSTRACT

Devices, systems, and methods for improving performance in positioning systems are disclosed. Signal processing methods are described for selecting certain spreading codes having desired auto and/or cross-correlation properties and generating, transmitting, and receiving signals generated using the selected codes.

### FIELD

This disclosure relates generally to positioning systems. More specifically, but not exclusively, the disclosure relates to devices, systems, and methods for coding signals for transmission from multiple transmitters in wide area positioning systems, as well as for receiving and processing such signals for determining location information in such systems.

### BACKGROUND

Systems for providing position information are known in the art. For example, radio-bases systems such as LORAN, GPS, GLONASS, and the like have been used to provide position information for persons, vehicles, equipment, and the like. In challenging environments, these systems do, however, have limitations associated with factors such as signal blockage and multipath. Accordingly, there is a need for improved positioning systems to address the above and/or other problems with existing positioning systems and devices.

### SUMMARY

This disclosure relates generally to positioning systems. More specifically, but not exclusively, the disclosure relates to devices, systems and methods for coding signals for transmission from multiple transmitters in wide area positioning systems, as well as for receiving and processing such signals for determining location information in such systems.

According to certain aspects, systems and methods may operate to: identify a set of digital pseudorandom sequences, wherein a magnitude of an autocorrelation function of each member of the set of digital pseudorandom sequences, within a specified zonal region adjacent to a peak of the autocorrelation function, is equal to or less than a first prescribed value; and identify a subset of digital pseudorandom sequences, from among two or more subsets of pseudorandom sequences in the set of pseudorandom sequences, that optimizes a performance criterion, wherein the performance criterion is associated with a relationship between members within any subset of the two or more subsets.

According to other aspects, systems and methods may operate to: identify a first pseudorandom sequence from a subset of pseudorandom sequences within a set of pseudorandom sequences, wherein a magnitude of an autocorrelation function of each member of the set of pseudorandom sequences, within a zonal region adjacent to a peak of the autocorrelation function, meets a threshold condition, and wherein the subset optimizes a performance criterion between its members compared to other subsets of the set.

According to other aspects, systems and methods may operate to: receive a first positioning signal that is encoded at least in part with a first pseudorandom sequence selected from a first subset of a set of pseudorandom sequences, wherein the set of pseudorandom sequences are characterized by having a magnitude of an autocorrelation function of each member of the set, within a specified zonal region adjacent to a peak of the autocorrelation function, equal to or less than a first prescribed value, and wherein the first subset is selected from among a group of subsets to optimize a performance criterion in comparison to the other subsets of the group, wherein the performance criterion is associated with a relationship between members of any subset of the group of subsets; receive a second positioning signal that is encoded at least in part with a second pseudorandom sequence from the subset of pseudorandom sequences; and determine, based at least in part on the first and second positioning signals, location information associated with a receiver.

Various additional aspects, features, and functions are described below in conjunction with the appended Drawings.

### BRIEF DESCRIPTION OF THE DRAWINGS

The present application may be more fully appreciated in connection with the following detailed description taken in conjunction with the accompanying drawings, wherein:

FIG. 1 illustrates details of a terrestrial location/positioning system on which embodiments may be implemented;

FIG. 2 illustrates details of an embodiment of a receiver/user device in accordance with certain aspects;

FIG. 3 illustrates details of an embodiment of a transmitter device in accordance with certain aspects;

FIG. 4 illustrates details of an embodiment of a set of PRN codes in accordance with certain aspects;

FIG. 5 illustrates an example worst-case cross-correlation rejection between selected codes from the codes of FIG. 4;

FIG. 6 illustrates details of an embodiment of a method of generating a set of pseudorandom codes for use in a WAPS system in accordance with certain aspects;

FIG. 7 illustrates details of an embodiment of a method of transmission of signals from transmitters in a WAPS system;

FIG. 8 illustrates details of an embodiment of a method of receiving signals from transmitters in a WAPS system and generating location information based on the received signals;

FIG. 9 illustrates details of an embodiment of a method of receiving and processing signals from two transmitters to determine location information in a WAPS system;

FIG. 10 illustrates details of an embodiment of a method of generating a set of pseudorandom codes for use in a WAPS system using frequency offset multiplexing (FOM) in accordance with certain aspects;

FIG. 11 illustrates details of an embodiment of a method of transmission of signals from transmitters in a WAPS system using FOM;

FIG. 12 illustrates details of an embodiment of a method of receiving signals from transmitters in a WAPS system using FOM and generating location information based on the received signals; and

FIG. 13 illustrates details of an embodiment of a method of receiving and processing signals from two transmitters to determine location information in a WAPS system using FOM.

### DETAILED DESCRIPTION OF EMBODIMENTS

This disclosure relates generally to positioning systems and methods for determining a position (also denoted herein as “location”) of a user device. More specifically, but not exclusively, the disclosure relates to devices, systems, and methods for coding signals for transmission from multiple transmitters in wide area positioning systems, as well as for receiving and processing such signals for determining location information in such systems.

It is noted that, in the context of this disclosure, a positioning system is one that localizes one or more of latitude, longitude, and altitude coordinates, which may also be described or illustrated in terms of one, two, or three dimensional coordinate systems (e.g., x, y, z coordinates, angular coordinates, and the like). The disclosure also relates generally to networks of transmitters configured to broadcast positioning signals to various user devices. A position of a particular user device may be computed by that user device using the broadcast position signal and (optionally) other information available to the user device from the transmitter, sensors at the user device, and other components. Alternatively, the position of the user device may be computed by a server that is coupled directly or indirectly (though other components) to the user device via wireless or wired means described elsewhere herein.

In the following description, numerous specific details may be introduced to provide a thorough understanding of, and enabling description for, the systems and methods described. One skilled in the relevant art, however, will recognize that these embodiments can be practiced without one or more of the specific details, or with other components, systems, and the like. In other instances, well-known structures or operations may be not shown, or may be not fully described, to avoid obscuring aspects of the embodiments.

### EXAMPLE EMBODIMENTS

As used herein, the term “exemplary” means serving as an example, instance or illustration. Any aspect and/or embodiment described herein as “exemplary” is not necessarily to be construed as preferred or advantageous over other aspects and/or embodiments.

It is noted that in the following description, numerous specific details are introduced to provide a thorough understanding of, and enabling description for, the systems and methods described. One skilled in the relevant art, however, will recognize that these embodiments can be practiced without one or more of the specific details, or with other components, systems, and the like. In other instances, well-known structures or operations are not shown, or are not described in detail, to avoid obscuring aspects of the disclosed embodiments.

In Wide Area Positioning Systems (WAPS) such as are described in, for example, co-assigned U.S. patent application Ser. No. 13/535,128, entitled WIDE AREA POSITIONING SYSTEMS AND METHODS, filed Jun. 27, 2012, the content of which is incorporated by reference herein, times of arrival of positioning signals sent from multiple transmitters are measured at a corresponding receiver to determine distances to known transmitter locations, and thereby allow position triangulation of the receiver. A fundamental limitation on performance in these systems is often imposed by received positioning signals with multipath components (also denoted as multipath signals). Multipath signals are one or more signals present at the receiver from reflections of the originally transmitted signal, which may be amplitude attenuated and/or phase shifted relative to a corresponding direct path signal between the transmitter and receiver. These delayed signals may distort the estimated time of arrival at the receiver in applications where distance is determined based on time of arrival of the direct path signal.

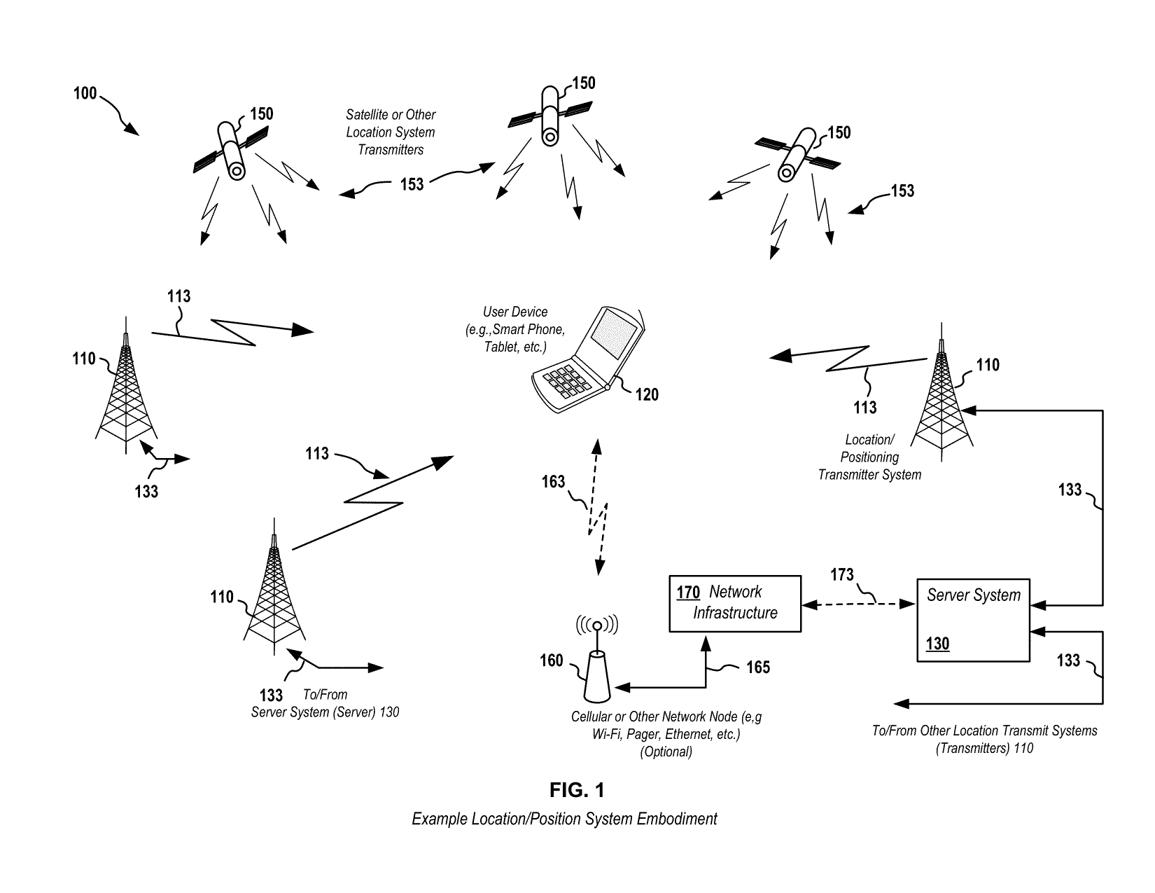

A typical WAPS implementation includes multiple towers broadcasting synchronized positioning signals to one or more mobile receivers, such as shown in the example system of FIG. 1, with the receivers determining distances to each of the transmitters for location determination by triangulation. In an exemplary embodiment, the towers 110 are terrestrially located, but other systems may use satellite or other non-terrestrial transmitters to implement similar location determination functionality. One or more receivers 120, which may be smart phones, tablet devices, dedicated location devices, or other devices, such as combinations of phones, GPS devices, other radio receivers, and the like, may be used in a typical system. For example, emergency responders may have positioning functionality configured on a cellular phone or other mobile device with receiving and computing capability. Alternately, dedicated mobile locating devices with receiver and processing capability may be used in some applications.

Turning to FIG. 1, a block diagram is illustrated of details of an example location/positioning system 100, on which various embodiments may be implemented. Positioning system 100, also referred to herein as a Wide Area Positioning System (WAPS), or “system” for brevity, includes a network of synchronized beacons (also denoted herein as “transmitters”), which are typically terrestrial, as well as user devices (also denoted herein as “receiver units” or “receivers” for brevity) configured to acquire, process and, optionally, track signals provided from the beacons and/or other position signaling, such as may be provided by a satellite system such as the Global Positioning System (GPS) and/or other satellite or terrestrially based position systems. The receivers may optionally include a location computation engine to determine position/location information from signals received from the beacons and/or satellite systems, and the system 100 may further include a server system in communication with various other systems, such as the beacons, a network infrastructure, such as the Internet, cellular networks, wide or local area networks, and/or other networks. The server system may include various system-related information and components, such as an index of towers, a billing interface, one or more encryption algorithm processing modules, which may be based on one or more proprietary encryption algorithms, a location computation engine module, and/or other processing modules to facilitate position, motion, and/or location determination for users of the system. The above described transmitters need not be restricted to only transmitting information, but may also have receiving functionality, both in wired and wireless configurations. For example, the transmitters may receive synchronization information from external entities. Similarly, the above described receivers normally have transmitting functionality, both in wireless and wired configurations. In some embodiments the receivers may transmit information to the transmitters wirelessly. In the following description emphasis is placed upon the transmitting functions of the transmitters and the receiving functions of the receivers; however, either or both may be include the alternate functionality in various embodiments.

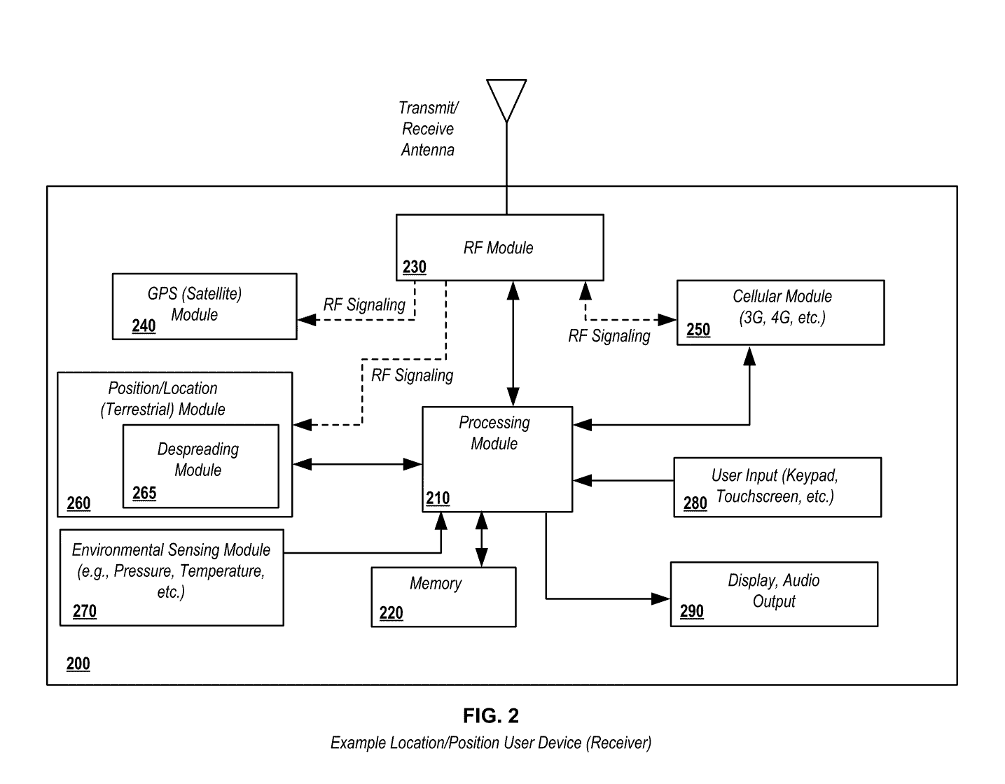

As shown in exemplary system 100, the beacons may be in the form of a plurality of transmitters 110, and the receiver units may be in the form of one or more user devices 120, which may be any of a variety of electronic communication devices configured to receive signaling from the transmitters 110, as well as optionally be configured to receive GPS or other satellite system signaling, cellular signaling, Wi-Fi signaling, Wi-Max signaling, Bluetooth, Ethernet, and/or other data or information signaling as is known or developed in the art. The receiver units 120 may be in the form of a cellular or smart phone, a tablet device, a PDA, a notebook or other computer system, and/or similar or equivalent devices. In some embodiments, the receiver unit may be a standalone location/positioning device configured solely or primarily to receive signals from the transmitters 110 and determine location/position based at least in part on the received signals. As described herein, receiver units 120 may also be denoted herein as “User Equipment” (UE), handsets, smart phones, tablets, and/or simply as a “receiver.” FIG. 2, described subsequently herein, illustrates a block diagram of details of an embodiment of receiver unit architecture as may be used in various embodiments.

The transmitters 110 (which may also be denoted herein as “towers”) are configured to send transmitter output signals to multiple receiver units 120 via communication links 113 as shown. A single receiver unit 120 is shown in FIG. 1 for simplicity; however, a typical system will be configured to support many receiver units within a defined coverage area. In a large scale system different receivers separated by large enough distances will typically be served by distinct sets of transmitters; such sets may be totally disjoint if the distances are large, or may have some transmitters in common. As noted previously, the transmitted signals may result in multiple signals being received at the receivers including both direct path signals and one or more multipath signals.

The transmitters 110 may also be connected to a server system 130 via communication links 133, and/or may have other communication connections (not shown) to a network infrastructure 170, such as via wired connections such as Ethernet, USB, and the like, and/or wireless connections such as cellular data connections, Wi-Fi, Wi-Max, or other wireless connections.

One or more receivers 120 may receive signaling from multiple transmitters 110 via corresponding communication links 113 from each of the transmitters 110. Signals received via communication links 113 may include both direct path components and multipath components reflected from terrain, buildings, or other surfaces or structures.

In addition, as shown in FIG. 1, a receiver 120 may also be configured to receive and/or send other signals, such as, for example, cellular network signals via communication link 163 from a cellular base station (also known as a NodeB, eNB, or base station), Wi-Fi network signals, Pager network signals, or other wired or wireless connection signaling, as well as satellite signaling via satellite communication links 153, such as from a GPS or other satellite positioning system. While the satellite positioning signaling shown in the exemplary embodiment of FIG. 1 is shown as being provided from GPS system satellites 150, in other embodiments the signaling may be provided from other satellite systems and/or, in some embodiments, terrestrial-based wired or wireless positioning systems or other data communication systems or positioning systems.

In an exemplary embodiment, the transmitters 110 of system 100 are configured to operate in an exclusively licensed or shared licensed/unlicensed radio spectrum; however, some embodiments may be implemented to provide signaling in unlicensed shared spectrum. The transmitters 110 may transmit signaling in these various radio bands using novel signaling as is described in co-assigned applications, such as in U.S. patent application Ser. No. 13/535,128, which is incorporated by reference herein. This signaling may be in the form of a proprietary signal configured to provide specific data in a defined format advantageous for location and navigation purposes. For example, the signaling may be structured to be particularly advantageous for operation in obstructed environments, such as where traditional satellite position signaling is attenuated and/or impacted by reflections, multipath, and the like. In addition, the signaling may be configured to provide fast acquisition and position determination times to allow for quick location determination upon device power-on or location activation, reduced power consumption, and/or to provide other advantages.

Various embodiments of WAPS may be combined with other positioning systems to provide enhanced location and position determination. Alternately, or in addition, a WAPS system may be used to aid other positioning systems. In addition, information determined by receiver units 120 of WAPS systems may be provided via other communication network links 163, such as cellular, Wi-Fi, Pager, and the like, to report position and location information to a server system or systems 130, as well as to other networked systems existing on or coupled to network infrastructure 170. For example, in a cellular network, a cellular backhaul link 165 may be used to provide information from receiver units 120 to associated cellular carriers and/or others (not shown) via network infrastructure 170. This may be used to quickly and accurately locate the position of receiver 120 during an emergency, or may be used to provide location-based services or other functions from cellular carriers or other network users or systems.

It is noted that, in the context of this disclosure, a positioning system is one that localizes one or more of latitude, longitude, and altitude coordinates, which may also be described or illustrated in terms of one, two, or three dimensional coordinate systems (e.g., x, y, z coordinates, polar coordinates, etc.). The positioning system may also provide time of day information to the various receivers. It is noted that whenever the term ‘GPS’ is referred to, it is done so in the broader sense of Global Navigation Satellite Systems (GNSS) which may include other existing satellite positioning systems such as GLONASS as well as newer and/or future positioning systems such as Galileo and Compass/Beidou. In addition, as noted previously, in some embodiments other positioning systems, such as terrestrially based systems, may be used in addition to or in place of satellite-based positioning systems.

Embodiments of WAPS include multiple towers or transmitters, such as multiple transmitters 110 as shown in FIG. 1, which broadcast WAPS data positioning information, and/or other data or information, in transmitter output signals to the receivers 120. The positioning signals may be coordinated so as to be synchronized across all transmitters of a particular system or regional coverage area. Transmitters may use a disciplined GPS clock source for timing synchronization. WAPS data positioning transmissions may include dedicated communication channel methodologies (e.g., amplitude, time, code, phase and/or frequency modulation and multiplexing methods) to facilitate transmission of data required for trilateration, notification to subscriber/group of subscribers, broadcast of messages, general operation of the WAPS network, and/or for other purposes such as are described subsequently herein and/or in the following co-assigned patent applications which are incorporated by reference herein: U.S. Utility patent application Ser. No. 13/412,487, entitled WIDE AREA POSITIONING SYSTEMS, filed on Mar. 5, 2012; U.S. Utility patent Ser. No. 12/557,479 (now U.S. Pat. No. 8,130,141), entitled WIDE AREA POSITIONING SYSTEM, filed Sep. 10, 2009; U.S. Utility patent application Ser. No. 13/412,508, entitled WIDE AREA POSITIONING SYSTEM, filed Mar. 5, 2012; U.S. Utility patent application Ser. No. 13/296,067, entitled WIDE AREA POSITIONING SYSTEMS, filed Nov. 14, 2011; Application Serial No. PCT/US12/44452, entitled WIDE AREA POSITIONING SYSTEMS, filed Jun. 28, 2011); U.S. patent application Ser. No. 13/535,626, entitled CODING IN WIDE AREA POSITIONING SYSTEMS, filed Jun. 28, 2012; U.S. patent application Ser. No. 13/536,051, entitled CODING IN WIDE AREA POSITIONING SYSTEM (WAPS), filed Jun. 28, 2012; U.S. patent application Ser. No. 13/565,614, entitled CELL ORGANIZATION AND TRANSMISSION SCHEMES IN A WIDE AREA POSITIONING SYSTEM (WAPS), filed Aug. 2, 2012; U.S. patent application Ser. No. 13/565,732, entitled CELL ORGANIZATION AND TRANSMISSION SCHEMES IN A WIDE AREA POSITIONING SYSTEM, filed Aug. 2, 2012; U.S. patent application Ser. No. 13/565,723, entitled CELL ORGANIZATION AND TRANSMISSION SCHEMES IN A WIDE AREA POSITIONING SYSTEM, filed Aug. 2, 2012; U.S. patent application Ser. No. 13/831,740, entitled SYSTEMS AND METHODS CONFIGURED TO ESTIMATE RECEIVER POSITION USING TIMING DATA ASSOCIATED WITH REFERENCE LOCATIONS IN THREE-DIMENSIONAL SPACE, filed Mar. 14, 2013; and U.S. patent application Ser. No. 13/909,977, entitled SYSTEMS AND METHODS FOR LOCATION POSITIONING of USER DEVICE, filed Jun. 4, 2013. The above applications, publications and patents may be individually or collectively referred to herein as “incorporated reference(s)”, “incorporated application(s)”, “incorporated publication(s)”, “incorporated patent(s)” or otherwise designated. The various aspect, details, devices, systems, and methods disclosed herein may be combined with disclosures in any of the incorporated references.

In a positioning system that uses time difference of arrival for trilateration, the positioning information typically transmitted includes one or more of precision timing sequences (alternatively called ranging sequences) and positioning (or position location) data, where the positioning data includes the location of transmitters and various timing corrections and other related data or information. In one WAPS embodiment, the data may include additional messages or information such as notification/access control messages for a group of subscribers, general broadcast messages, and/or other data or information related to system operation, users, interfaces with other networks, and other system functions. The positioning data may be provided in a number of ways. For example, the positioning data may be modulated onto a coded timing sequence, added or overlaid over the timing sequence, and/or concatenated with the timing sequence.

Data transmission methods and apparatus described herein may be used to provide improved location information throughput for the WAPS. In particular, the positioning data may be provided by higher order modulation transmitted as a separate portion of information from pseudo-noise (PN) timing, or ranging, sequences. This may be used to allow improved acquisition speed in systems employing CDMA multiplexing, TDMA multiplexing, frequency offset multiplexing (FOM) or a combination of each of these. The disclosure herein is illustrated in terms of wide area positioning systems in which multiple towers broadcast synchronized positioning signals to mobile receivers and, more particularly, using towers that are terrestrial; however, the embodiments are not so limited and other systems within the spirit and scope of the disclosure may also be implemented.

In an exemplary embodiment, a WAPS uses coded modulation sent from a tower or transmitter, such as transmitter 110, called spread spectrum modulation or pseudo-noise (PN) modulation, to achieve wide bandwidth. The corresponding receiver unit, such as receiver or user device 120, includes one or more modules to receive the transmitted signals and process the received signals using a despreading circuit, such as a matched filter or a series of correlators, for example. Such a receiver produces a waveform which, ideally, has a strong peak surrounded by lower level energy. The time of arrival of the peak represents the time of arrival of the transmitted signal at the mobile receiver. Performing this operation on a multiplicity of signals from a multiplicity of towers, whose locations are accurately known, allows determination of the receiver's location via trilateration. Various additional details related to WAPS signal generation in a transmitter, such as transmitter 110, along with received signal processing in a receiver, such as receiver 120, are described subsequently herein.

In one embodiment, a WAPS may use binary coded modulation as the spreading method. The WAPS signals of an exemplary embodiment may include two specific types of information: (1) a high speed ranging signal, and (2) position location data such as transmitter ID and position, time of day, health, environmental conditions such as pressure data, etc. WAPS may, similar to GPS, transmit location information by modulating a high speed binary pseudorandom ranging signal with a lower rate information source. In addition to this application, the disclosures of the incorporated applications describe embodiments of methods and devices that use a pseudorandom ranging signal and a modulating information signal, both of which may utilize higher order modulations, such as quaternary or octonary modulation. These disclosures may be combined with the descriptions herein in various alternate embodiments. In one embodiment, the ranging signal is binary phase modulated, and location information is provided in a separate signal using higher order modulation.

Conventional systems often use a format of a position location signal (e.g., used in a Time Division Multiplexing arrangement) in which each transmission slot comprises a pseudorandom ranging signal followed by various types of location data. These conventional systems also include a synchronization, or sync, signal, which may be deleted if the pseudorandom ranging signal is used also as the sync signal. However, as with other earlier systems, the location data of these conventional systems is normally binary, which limits throughput.

To address these limitations, in exemplary embodiments, a binary, or quaternary, pseudorandom signal may be transmitted in a particular slot followed by a higher order modulated data signal. For example, in a given slot one or more location information symbols may be transmitted using differential 16-phase modulation, in order to transmit four bits of information per slot. This represents a four-fold throughput improvement versus the one bit typically transmitted when binary phase modulation is imposed upon the pseudorandom carrier. Other types of modulation of location information may also be utilized, such as 16 QAM, etc. In addition certain error control modulation methods may be used for the higher level modulation, such as the use of Trellis codes. These error control modulation methods generally reduce error rates.

Performing operation on a multiplicity of signals from a multiplicity of towers, whose locations are accurately known, allows determination of the mobile's location via trilateration algorithms. For example, in the WAPS of FIG. 1, three or more towers 110 may send uniquely encoded signals to the receiver 120, which may then estimate the distance to each tower and triangulate a position from the estimated distances. However, distance estimation errors due to multipath may introduce triangulation errors, and in some cases, such as described subsequently herein, may cause catastrophic errors in location determination. This can be extremely problematic in applications such as first-response during emergencies and the like.

In WAPS systems operating in multipath environments, a mobile receiver, such as a cellular phone 120 or other integrated or standalone receiver device, may receive multiple delayed “copies” (also referred to herein as multipath components) of a single transmitted signal, such as signal 113 from one of the towers 110 of FIG. 1, with the multiple signals corresponding to a multiplicity of reflected paths as well as (in many cases) a direct path signal component between each transmitter and the receiver. The delayed signals may be due to reflective surfaces in the operating environment such as buildings or other structures, terrain, and the like. These delayed signals may also be attenuated and/or phase shifted, relative to a direct line of sight signal, if one exists.

Turning to FIG. 2, an example embodiment of details of a positioning system receiver 200 is illustrated. Receiver embodiment 200 may be part of a user device such as a smart phone, tablet, or other device which transmitted positioning signals may be received and processed to determine location/position information in one or more processing elements. Receiver embodiment 200 may correspond with user device 120 as shown in FIG. 1.

Receiver 200 may include one or more GPS modules 240 for receiving GPS signals and determining location information and/or other data, such as timing data, dilution of precision (DOP) data, or other data or information as may be provided from a GPS or other positioning system, and providing the determined information to processing module 210 and/or other modules of the receiver. It is noted that while receiver 200 is shown in FIG. 2 with a GPS module, other modules for receiving satellite or terrestrial signals and providing similar or equivalent output signals, data, or other information may alternately be used in various embodiments.

Receiver 200 may also include one or more cellular modules 250 for sending and receiving data or information via a cellular or other data communications system. Alternately, or in addition, receiver 200 may include communications modules (not shown) for sending and/or receiving data via other wired or wireless communications networks, such as Wi-Fi, Wi-Max, Bluetooth, USB, Ethernet, or other data communication networks.

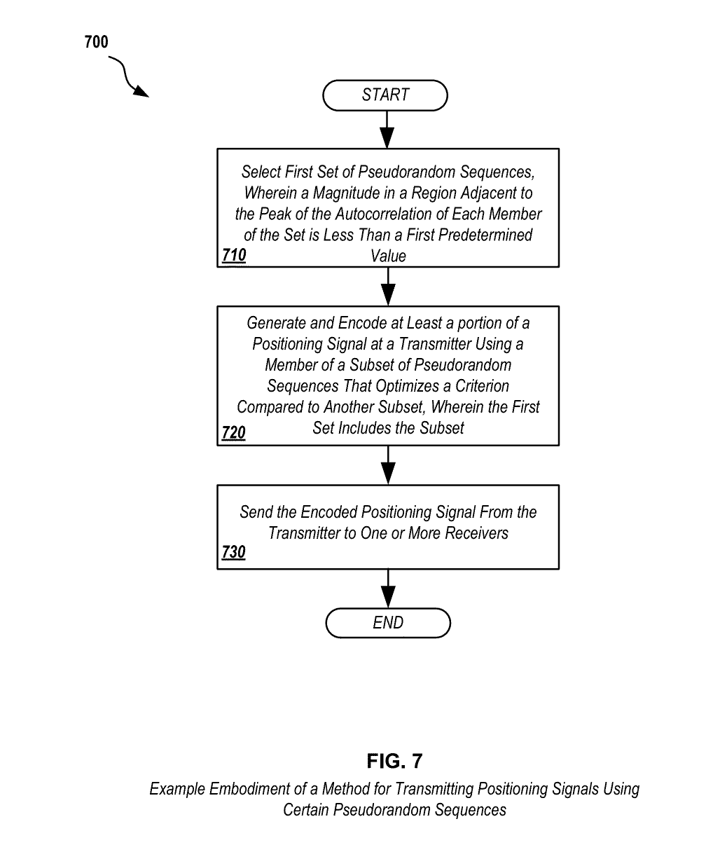

Receiver 200 may include one or more position/location modules for receiving signals from terrestrial transmitters, such as transmitters 110 as shown in FIG. 1, and processing the signals to determine position/location information as described subsequently herein, including for performing multipath signal processing as described subsequently with respect to FIGS. 7-13. Module 260 may be integrated with and/or may share resources such as antennas, RF circuitry, and the like with other modules, such as, for example, GPS module 240. For example, Position module 260 and GPS module 240 may share some or all radio front end (RFE) components and/or processing elements. Processing module 210 may be integrated with and/or share resources with Position module 260 and/or GPS module 240 to determine position/location information and/or perform other processing functions as described herein. Similarly, cellular module 250 may share RF and/or processing functionality with RF module 230 and/or processing module 210. A despreading module 265 may be incorporated in position module 260 and/or processing module 210 in various embodiments, or may be a separate module or part of the RF receiver module 230.

One or more memories 220 may be coupled with processing module 210 to provide storage and retrieval of data and/or to provide storage and retrieval of instructions for execution in the processing module 210. For example, the instructions may be for performing the various processing methods and functions described subsequently herein, such as for performing multipath signal processing, determining location information or other information based on receptions from a transmitter, GPS, cellular, pressure, temperature, and/or other signals or data, or for implementing other processing functions.

Receiver 200 may further include one or more environmental sensing modules 270 for sensing or determining conditions associated with the receiver, such as, for example, local pressure, temperature, or other conditions. In an exemplary embodiment, pressure information may be generated in environmental sensing module 270 and provided to processing module 210 for use in determining location/position information in conjunction with receptions from a transmitter, GPS, cellular, or other signals.

Receiver 200 may further include various additional user interface modules, such as a user input module 280, which may be in the form of a keypad, touchscreen display, mouse, or other user interface element. Audio and/or video data or information may be provided on an output module 290, such as in the form of one or more speakers or other audio transducers, one or more visual displays, such as LCD displays, touchscreens, and/or other user I/O elements as are known or developed in the art. In an exemplary embodiment, output module 290 may be used to visually display determined location/position information based on received transmitter signals. The determined location/position information may also be sent to cellular module 250 to an associated carrier or other entity.

In a typical positioning system receiver, such as receiver embodiment 200 of FIG. 2, a matched filter is used to process a received spread spectrum signal. The matched filter may be implemented in a processing element, such as processing module 210, or in other receiver modules such as position module 260, or other modules, such as despreading module 265. A set of correlators may be used instead of a matched filter to provide information similar to that provided by a matched filter.

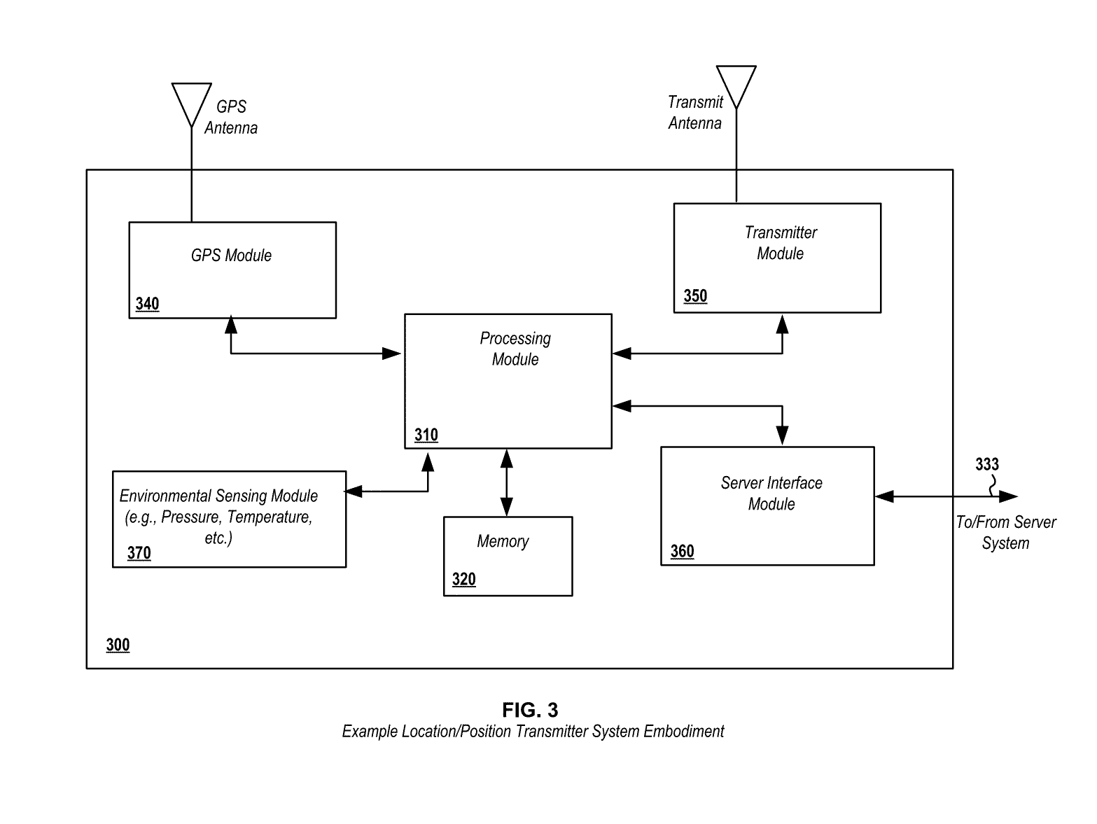

FIG. 3 is a block diagram illustrating details of one embodiment 300 of a beacon/transmitter system from which location/positioning signals as described subsequently herein may be sent. Transmitter embodiment 300 may correspond with transmitters 110 as shown in FIG. 1. It is noted that transmitter embodiment 300 includes various blocks for performing associated signal reception and/or processing; however, in other embodiments these blocks may be combined and/or organized differently to provide similar or equivalent signal processing, signal generation, and signal transmission.

As shown in FIG. 3, transmitter/beacon embodiment 300 may include one or more GPS modules 340 for receiving GPS signals and providing location information and/or other data, such as timing data, dilution of precision (DOP) data, or other data or information as may be provided from a GPS or other positioning system, to a processing module 310. It is noted that while transmitter 300 is shown in FIG. 3 with a GPS module, other modules for receiving satellite or terrestrial signals and providing similar or equivalent output signals, data, or other information may alternately be used in various embodiments. GPS or other timing signals may be used for precision timing operations within transmitters and/or for timing correction across the WAPS network.

Transmitter 300 may also include one or more transmitter modules 350 for generating and sending transmitter output signals as described subsequently herein. Transmitter module 350 may also include various elements as are known or developed in the art for providing output signals to a transmit antenna, such as analog or digital logic and power circuitry, signal processing circuitry, tuning circuitry, buffer and power amplifiers, and the like. Signal processing for generating the output signals may be done in the processing module 310 which, in some embodiments, may be integrated with the transmitter module 350 or, in other embodiments, may be a standalone processing module for performing multiple signal processing and/or other operational functions.

One or more memories 320 may be coupled with processing module 310 to provide storage and retrieval of data and/or to provide storage and retrieval of instructions for execution in the processing module 310. For example, the instructions may be instructions for performing the various processing methods and functions described subsequently herein, such as for determining location information or other information associated with the transmitter, such as local environmental conditions, as well as to generate transmitter output signals using certain spreading codes as described herein to be sent to the user devices 120 as shown in FIG. 1.

Transmitter 300 may further include one or more environmental sensing modules 370 for sensing or determining conditions associated with the transmitter, such as, for example, local pressure, temperature, or other conditions. In an exemplary embodiment, pressure information may be generated in environmental sensing module 370 and provided to processing module 310 for integration with other data in transmitter output signals as described subsequently herein. One or more server interface modules 360 may also be included in transmitter 300 to provide an interface between the transmitter and server systems, such as system 130 as shown in FIG. 1, and/or to a network infrastructure, such as network infrastructure 170 as shown in FIG. 1. For example, system 130 may send data or information associated with the location system and/or user devices to transmitters 300 via interface module 360. In addition, transmitter 300 may include other modules (not shown) to provide related operational functionality.

In one aspect as described herein, spreading codes and methods and apparatus for use are disclosed which provide improved structure to allow multipath mitigation for wide area positioning systems., with the transmitters configured to generate signals using such codes and the corresponding receivers configured to receive such coded signals and process them to determine location information. In exemplary embodiments, spreading codes are described with very good auto and cross correlation properties. These codes may be used in multiple access systems employing CDMA multiplexing, TDMA multiplexing, frequency offset multiplexing (FOM) or a combination of CDMA, TDMA, and FOM. The latter combination is referred to as “hybrid” multiplexing.

As noted previously, a typical WAPS includes multiple towers broadcasting synchronized positioning signals to mobile receivers. The towers may be terrestrial, but do not necessarily need to be. Terrestrial systems, and especially ones that operate in urban environments, are often impacted by multipath. In these situations, the mobile receiver may receive a multiplicity of signals from one or more of the transmitters, corresponding to a multiplicity of direct and reflected paths. The range of delays, also referred to as the delay spread, is typically constrained by geometric situations in the particular operating environment. For example, a delay spread of 1 microsecond corresponds to a maximum differential path length of 300 meters, and a spread of 5 microseconds to 1500 meters.

Typical WAPS transmit coded modulated signals, in the form of spread spectrum modulation or pseudo noise (PN) modulation, to achieve wide bandwidth. The mobile receiver processes such signals with a despreading circuit, typically a matched filter or a series of correlators. Such a receiver produces a waveform which ideally has a strong peak surrounded by lower level energy. The time of arrival of the peak represents the time of arrival of the transmitted signal at the mobile receiver. Performing this time of arrival operation on a multiplicity of signals from a multiplicity of towers, whose locations are accurately known, allows determination of the mobile's location via trilateration algorithms.

Assuming use of a matched filter to process a received spread spectrum signal, when multipath is present the matched filter output produces a series of overlapping sharp pulses of varying amplitudes, delays and phases. The mobile receiver processes these signals to estimate the time of arrival of the earliest such pulse. A variety of algorithms may be used for this purpose, such as leading edge location algorithms, MUSIC algorithm, minimum mean square estimation algorithms, and the like.

One problem that arises, however, is that the energy surrounding the peak typically contains a series of subsidiary peaks, or “side lobes.” The structure of such side lobes in an ideal situation (i.e. no noise or multipath) is described by a function called the “autocorrelation function.”

In multipath environments, these subsidiary peaks may be confused with a weak early signal arrival. For example, in the GPS system, for the C/A civilian codes, certain binary spreading codes, called “Gold Codes”, are used, which are of frame length 1023 symbols, or “chips.” An ideal matched filter receiving such a Gold code produces a set of side lobes of amplitude −65/1023 times the peak amplitude, 63/1023 times the peak amplitude and −1/1023 times the peak amplitude. Thus the magnitude of the largest side lobe is approximately 0.06 times the peak amplitude, or −24 dB. Typically these large amplitude side lobes may be adjacent to or close to the peak amplitude of the autocorrelation function. In general in a severe multipath environment (e.g. in urban canyons) one seeks much better side lobe rejection, at least within a range about the autocorrelation function peak. U.S. patent application Ser. No. 13/535,626, entitled CODING IN WIDE AREA POSITIONING SYSTEMS, filed Jun. 28, 2012; and U.S. patent application Ser. No. 13/536,051, entitled CODING IN WIDE AREA POSITIONING SYSTEM (WAPS), filed Jun. 28, 2012, which are incorporated herein by reference, provide a methodology for choosing codes with very good side lobe rejection. Although various algorithms (such as the MUSIC algorithm) can in principle deal with side lobes of varying levels, simulations have indicated that in real world situations such side lobes are often confused with true early signals, or hide these early signals. This is particularly true when the processed signal-to-noise ratios are low.

It is noted that, as used herein, the terms autocorrelation and cross-correlation refer to circular autocorrelation and circular cross-correlation. This is appropriate since in typical WAPS implementations repeated sequences are used, thereby allowing wrap-around. In other cases, attention may be placed upon restricted ranges of code offsets, in which case even if the sequences do not repeat, the autocorrelations and cross correlations over restricted ranges may be approximated as those of a circular variety.

In a WAPS system multiple transmitters are typically transmitting simultaneously, and such transmissions may be received concurrently by a receiver whose position is to be determined. It is necessary for such a receiver to distinguish such simultaneous signals from one another in order to determine the times of arrivals of the individual constituent signals, and hence allow trilateration based upon this information.

In order to accomplish this, at least two approaches may be utilized: (1) choose codes transmitted from different transmitters with good cross-correlation properties and (2) utilize signal processing and filtering methods to further reduce the cross-correlations. Consequently, approach (1) requires having code sets whose members have excellent autocorrelation side lobe properties (at least over a limited range about the location of the autocorrelation peak) and the cross-correlation rejection between different members should be low. An approach to (2) includes the use of an additional multiplexing method, termed “Frequency Offset Multiplexing (FOM),” as described in co-assigned U.S. patent application Ser. No. 13/565,614, entitled CELL ORGANIZATION AND TRANSMISSION SCHEMES IN A WIDE AREA POSITIONING SYSTEM, filed Aug. 2, 2012; U.S. patent application Ser. No. 13/565,732, entitled CELL ORGANIZATION AND TRANSMISSION SCHEMES IN A WIDE AREA POSITIONING SYSTEM, filed Aug. 2, 2012; and U.S. patent application Ser. No. 13/565,723, entitled CELL ORGANIZATION AND TRANSMISSION SCHEMES IN A WIDE AREA POSITIONING SYSTEM, filed Aug. 2, 2012, which are incorporated herein by reference. In FOM, different transmitted signals may utilize slightly different carrier frequencies. By integrating such signals over a long interval, typically an interval equal to a multiplicity of PN frame periods, a receiver may achieve significant cross-correlation rejection

In the FOM method the carrier frequencies of differing (typically neighboring) transmitters are chosen to be slightly offset from one another (typically by values less than 1%). The transmitting signals include a repetition of a coded sequence. The receiver may integrate over a multiplicity of such repetitions, i.e. a multiplicity of frames, and it may thereby achieve very large additional rejection of other simultaneously received signals having different frequency offsets. By properly choosing the frequency offset parameters and the number of frames integrated, the receiver may ideally completely eliminate the cross interference from the other simultaneously received signals. The effectiveness of this approach is limited however, in the presence of Doppler induced by motion of the receiving platform. Nevertheless, approach (2) in most cases provides significant improvement over use of approach (1) alone.

Consequently, for an exemplary embodiment of a system incorporating at least CDMA and FOM it is desirable that a code set be chosen with the following objectives:

(1) each code should have excellent autocorrelation side lobe properties (at least over a limited range about the location of the autocorrelation peak);

(2) each pair of different codes should have good cross-correlation properties for all possible frequency offset differences. In the evaluation of the second objective the cross-correlation may be performed over an interval equal to the pseudorandom code period.

In order to meet the above objectives, in an exemplary embodiment the following procedures may be used: (1) Choose a large set of codes each of which has very good autocorrelation properties, at least within a zonal region about the autocorrelation peak location; (2) Then from this set examine subsets of these codes to determine a subset such that all pairs of different codes have good cross-correlation properties, either for all pairs of members (when FOM is not used) or for all pairs of members over all possible frequency offset differences (when FOM is used). In some implementations, such as when FOM is not employed, it is advantageous only to determine a subset such that all pairs of codes have good cross-correlation properties for zero frequency offset. In more general embodiments, instead of procedure (2), a performance criterion is established, including a relationship between members of a chosen subset, and a final subset is chosen which optimizes such a criterion. The prior example incorporated the cross-correlation between members of the subset, but other criteria could include different measures. For example, if the set of codes are simply code phase shifted versions of one another, one might choose as a criterion determining a subset from a multiplicity of subsets having the largest possible code phase shifts relative to one another.

One measure, of the quality of the autocorrelation property is the maximum magnitude of the autocorrelation peak, except for that at the peak, within a zonal region about the autocorrelation peak location. In some embodiments the autocorrelation performance may be more important than the (optimized) cross-correlation performance. In one embodiment this maximum zonal autocorrelation magnitude about the peak is chosen to be less than that of the cross-correlation peak magnitude (for all codes in a chosen subset) by some value. For example, the autocorrelation magnitude may be equal to or less than one-half (½) of the cross-correlation magnitude. Alternatively, the autocorrelation magnitude may be equal to or less than one-tenth ( 1/10) of the cross-correlation magnitude, which may be preferred in some embodiments. For example, such a strict autocorrelation condition may be required for situations when there is significant multipath in order to maximize the probability of detecting a direct path signal. Of course, different threshold conditions are possible with values below 1/10, above ½, and between ½ and 1/10 depending on system requirements. Furthermore, inverse conditions (e.g., where the ratio or difference between autocorrelation magnitude and the cross-correlation magnitude would not achieve a desired result) may be recognized and used to exclude sequences, subsets or sets instead of identifying desirable sequences, subsets or sets. Other quality measures are possible, such as the RMS value of the magnitudes in the zonal region, the second largest magnitude in the zonal region, etc.

One measure, or criterion, of the quality of the cross-correlation property (if this criterion is used) is simply the largest cross-correlation value over all possible code phases and frequency offsets. Other criteria may be used such as only considering the maximum cross-correlation over restricted code phase regions, or the RMS value of the cross-correlation, among others. The quality measures of the autocorrelations and cross-correlations may differ. In many of the examples that follow, the quality measures utilized are the maximum autocorrelation magnitude, except at the peak location, and the maximum cross-correlation magnitude. This is provided for the purposes of clarity. However, as indicated above, many other quality measures may be utilized in substitution for these quality measures.

It is noted that the above approach applies to a variety of possible coded signals. The most common spreading method uses binary coded modulation which incorporates binary codes such as Gold Codes, maximal length pseudorandom sequences, Kasami Codes, etc. Other spreading methods utilize quaternary coding sequences in which the two bits per code interval, or “chip”, determines one of four carrier phases to be transmitted. There are direct methods of choosing such quaternary sequences, as well as methods in which a combination of two codes, such as Gold Codes are used, as described in U.S. patent application Ser. No. 13/565,614, entitled CELL ORGANIZATION AND TRANSMISSION SCHEMES IN A WIDE AREA POSITIONING SYSTEM, filed Aug. 2, 2012; U.S. patent application Ser. No. 13/565,732, entitled CELL ORGANIZATION AND TRANSMISSION SCHEMES IN A WIDE AREA POSITIONING SYSTEM, filed Aug. 2, 2012; and U.S. patent application Ser. No. 13/565,723, entitled CELL ORGANIZATION AND TRANSMISSION SCHEMES IN A WIDE AREA POSITIONING SYSTEM, filed Aug. 2, 2012, which are incorporated by reference herein. Further, there are other sets of codes which use sequences whose elements are defined by digital words with a larger number of bits than two. All of these code types may be utilized in the choosing of the desired code set as discussed above using the same or a similar procedure to identify code sets having both good autocorrelation and cross-correlation properties.

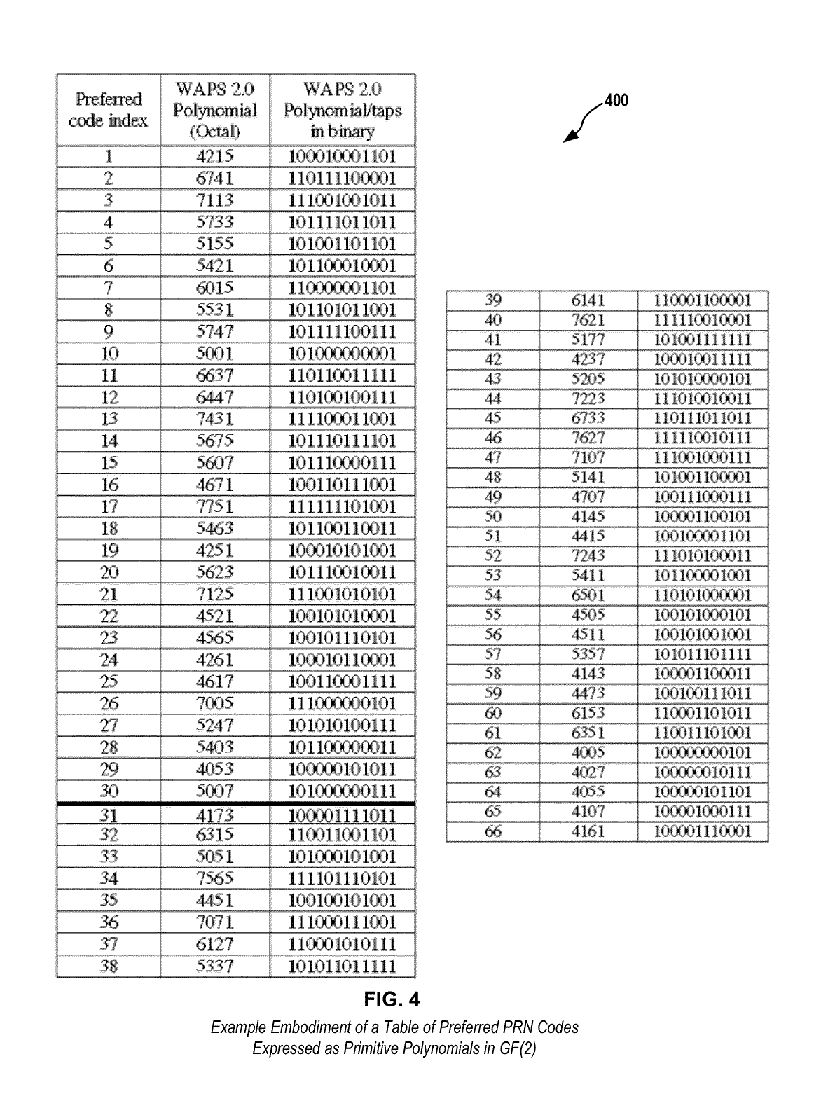

In one exemplary embodiment, a subset of binary maximal length sequences may be used. For this example embodiment, the sequence length is chosen to be 2047 chips with a chip rate of 2.047 MHz, producing a PN frame duration of 1 msec. The (circular) autocorrelation of a maximal length sequence is nearly ideal in that the side lobes are all of value −1/2047 relative to the peak value. A search was performed on the set of maximal length sequences of length 2047 for good cross-correlation properties between members of a subset of such sequences, across both code phase offset and frequency offset, with the latter in the range 0 to 8 kHz. An ordered list of good PN codes having these properties is provided in table 400 of FIG. 4. In particular, the first 30 sequences (those above the bold horizontal line) had worst case cross-correlation of around −20.9 dB whereas when one includes additional PN codes (those below the bold line) this increases to around −17 dB. Hence, the choice of the subset of 30 codes improves the worst case cross-correlation rejection by around 4 dB. Restricting this set to the first 15 codes improves the cross-correlation rejection by another 0.7 dB.

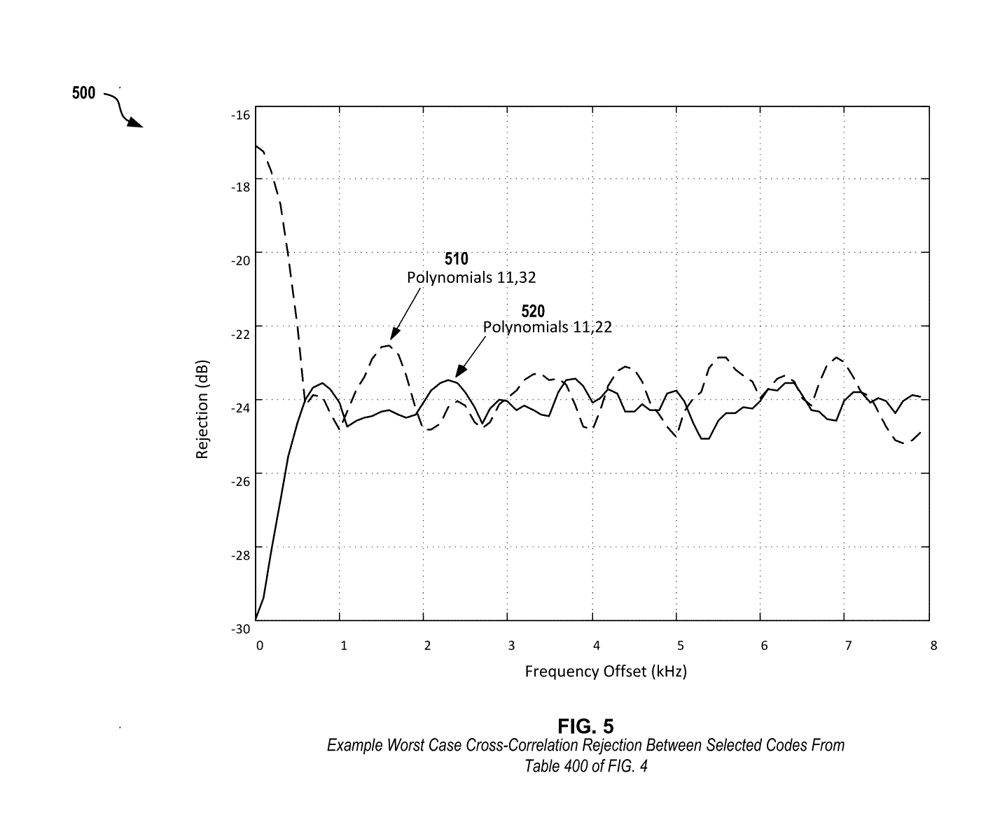

For this example embodiment, the greatest improvement in cross-correlation rejection is for offset frequency differences in the range 0 to 1 kHz. FIG. 5 shows cross-correlation rejection graph 500 for two pairs of codes, the first pair with the polynomials 11 and 22 (510) in Table 1 and the second pair with polynomials 11 and 32 (520). The plotted points show the worst case cross-correlation rejection over all code phases for a frequency offset between codes provided along the abscissa. One can see that the second pair has significantly poorer cross-correlation rejection in the range 0 to 1 kHz. Hence choosing codes in accordance with this embodiment produces codes with exceptional autocorrelation performance and, furthermore, has significant advantages for cross-correlation rejection when CDMA and FOM are used, or for the case of CDMA alone.

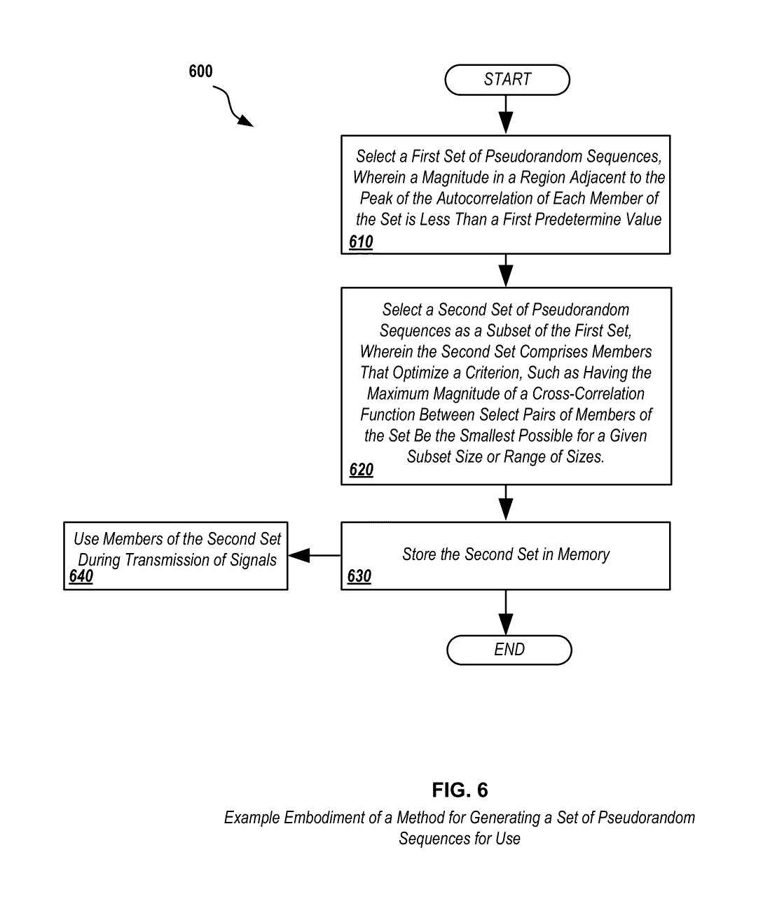

FIG. 6 illustrates details of an embodiment 600 of a process for determining or generating a set of pseudorandom sequences for use in a WAPS system, such as for encoding at least a portion of a transmitted positioning signal. At stage 610, a first set of pseudorandom sequences may be selected such as described previously herein. For example, the first set of pseudorandom sequences may be selected such that the magnitude of the autocorrelation function (except at the peak) of each member of the set is less than a predetermined value or threshold. At stage 620, a second set of pseudorandom sequences may be selected as a subset of the first set that meets an optimized criterion. Subsets of the same or similar size may be analyzed to determine which subset optimizes or achieves acceptable results in relation to a performance criterion. Sizes that are similar may be those that fall within a range of sizes (e.g., the size of the sets may be S+/−X, where X may be selected depending on the circumstances). As an example of the optimize criterion, the second set may be selected such that it minimizes the maximum magnitude of the cross-correlation function between all pairs of members of the second set Selecting the second set this way may be used to minimize the value of cross-talk in a receiver during matched filter or correlation processing, such as described previously herein. At stage 630, the second set of pseudorandom codes may be stored in a memory. The memory may be in a server system or other electronic device or system, or may be in a transmitter in a WAPS, such as transmitter 110 as shown in FIG. 1. If the memory is in a server or other system, such as server system 130, the second set of pseudorandom codes may be provided, at stage 640, to one or more transmitters of a WAPS system for use in encoding transmitted positioning signals.

FIG. 7 illustrates details of an embodiment 700 of a process for sending a positioning signal in a WAPS, with the positioning signal encoding at least in part using a pseudorandom code from a set of pseudorandom codes as described herein. At stage 710, a pseudorandom sequence may be selected from the set of pseudorandom sequences. The set of pseudorandom sequences may be a set as described previously with respect to FIG. 6, such as all members of the set have a magnitude of their autocorrelation function (except at the peak) less than a predefined value. At stage 720, a positioning signal may be further selected in accordance with the optimization of a criterion, and then generated in a WAPS transmitter. At least a portion of the positioning signal may be encoded using the selected pseudorandom sequence. The pseudorandom sequence may be selected by the WAPS transmitter, or provided to the WAPS transmitter from another system, such as the server system shown in FIG. 1. At stage 730, the generated positioning signal may be sent or broadcast from the WAPS transmitter and may then be received at one or more WAPS receivers. The WAPS receivers may have the pseudorandom sequence or set of sequences stored in a memory, or may utilize circuitry for the generation of such sequences, for use in demodulating and/or decoding the received positioning signal. In a typical embodiment, multiple positioning signals, using two or more different pseudorandom sequences from the set of pseudorandom sequences, may be sent from different WAPS transmitters to the WAPS receiver.

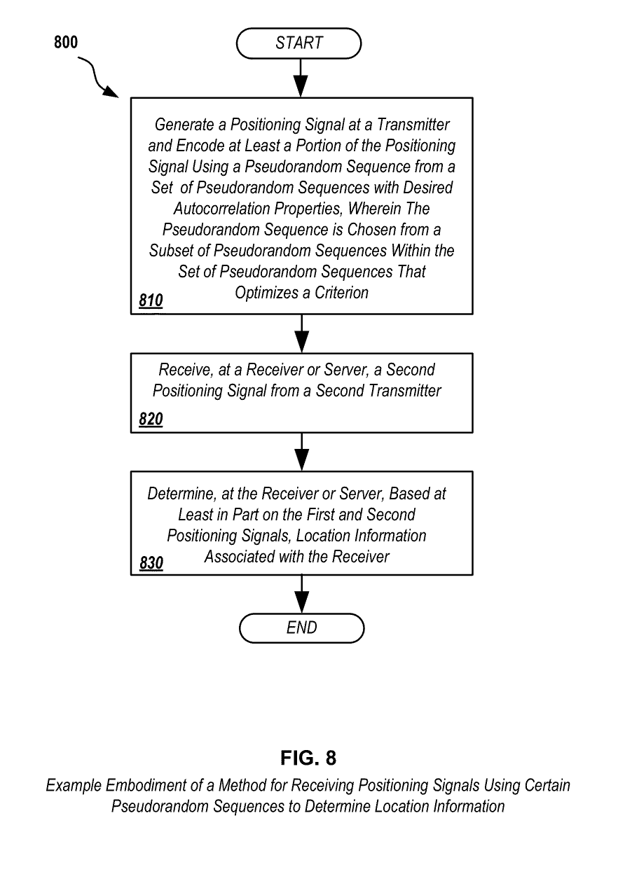

FIG. 8 illustrates details of an embodiment 800 of a process for receiving positioning signals in a WAPS using certain pseudorandom codes as described herein. The receiver may be a device such as user device 120 of FIG. 1 or another integrated or standalone device. At stage 810, a first positioning signal, which may be encoded at least in part using a pseudorandom sequence from a set with desired autocorrelation properties, and further selected from the subset of pseudorandom sequences optimizing a performance criterion (such as optimized cross-correlation properties). At stage 820, a second positioning signal, from a second WAPS transmitter, may be received at the WAPS receiver. The second positioning signal may be encoded with a second pseudorandom sequence from the set of pseudorandom sequences having magnitudes of cross-correlation functions between all pairs of members of the set less than a predetermined threshold. At stage 830, at the WAPS receiver, the received first positioning signal and the received second positioning signal may be processed, such as described in the incorporated applications, to determine location information associated with a location of the WAPS receiver. For criterion relating to minimized cross-correlation, the crosstalk associated with the first signal will be minimized when processing the second signal. Similarly, the crosstalk associated with the second signal will be minimized when processing the first signal. A similar procedure may be used when receiving three or more signals.

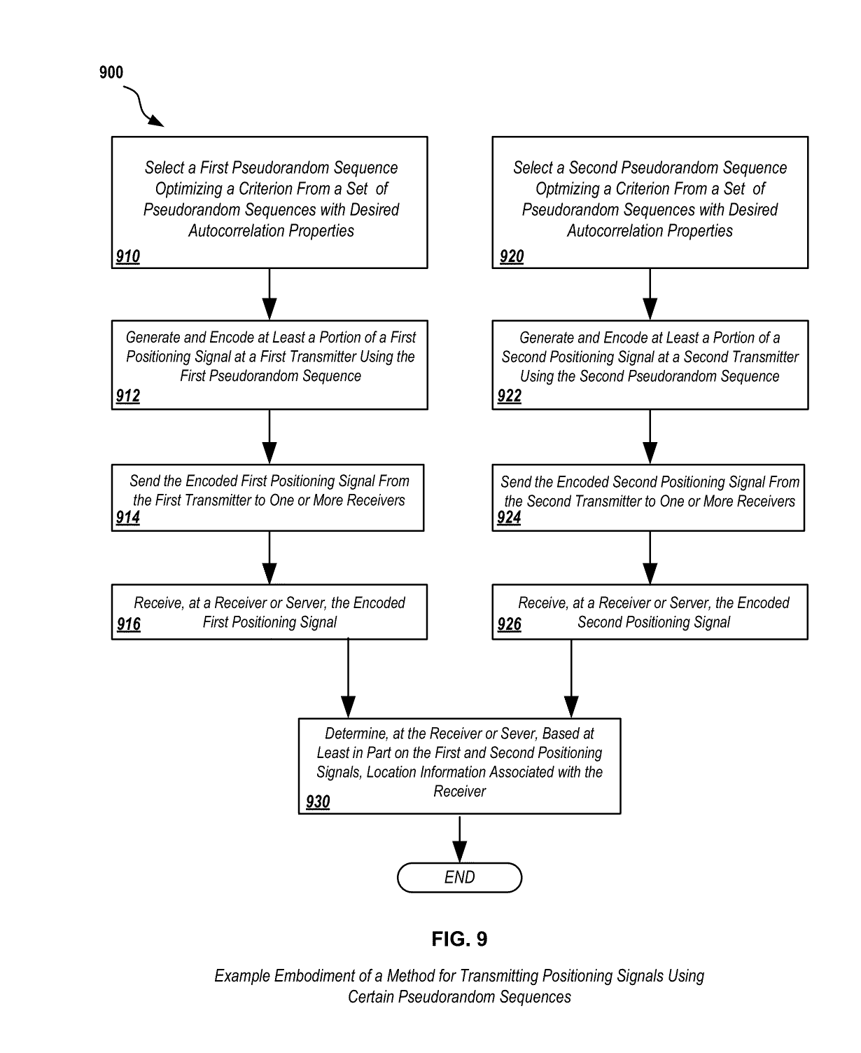

FIG. 9 illustrates details of an embodiment of a process 900 for transmitting positioning signals in a WAPS system from two (or more) WAPS transmitters and receiving and processing the signals to determine location information at a corresponding WAPS receiver. Stages 910 through 914 represent stages in a first WAPS transmitter, and stages 920-924 represent stages in a second WAPS transmitter. These stages may be implemented approximately simultaneously in both transmitters such that the signals from each are received at a corresponding WAPS receiver at times that differ primarily due to differences in the ranges from the transmitters to the receiver. At stage 910, a first pseudorandom sequence may be selected from a set of pseudorandom sequences, where members of the set of pseudorandom sequences all have autocorrelation functions (except at the peak) less than a predetermined value. The sequence also is chosen to optimize another performance criterion. Similarly, at stage 920, a second pseudorandom sequence may be selected from the set of pseudorandom sequences. This sequence may also be chosen to optimize an additional performance criterion such as belonging to a subset that minimizes the maximum magnitude of the cross-correlation for a given subset size or range of subset sizes (e.g., subsets that include n+/−k sequences, where k can be any number depending on the circumstances, and ideally no more than a fraction of n). The first and second pseudorandom sequences may be selected well in advance of transmission of positioning signals, and may be generated in an external system, such as the server system 130 shown in FIG. 1, and communicated to the first and second transmitters, which may be transmitters such as two of the transmitters 110 of FIG. 1. Alternately, the first and second pseudorandom sequences may be generated in one or both of the transmitters, and/or may be communicated between the transmitters to coordinate transmit operation.

At stages 912 and 922, first and second positioning signals may be generated at the first and second WAPS transmitters, with the first and second positioning signals encoded at least in part using the corresponding first and second pseudorandom sequences. At stages 914 and 924, the first and second positioning signals may be sent or transmitted from the first and second WAPS transmitters, and both may be received at a corresponding WAPS receiver at stages 916 and 926. At stage 930, at the WAPS receiver, location information associated with a location of the WAPS receiver may be determined based at least in part on the first and second positioning signals. The location information may be determined using, for example, signal processing techniques as described herein and in the incorporated applications.

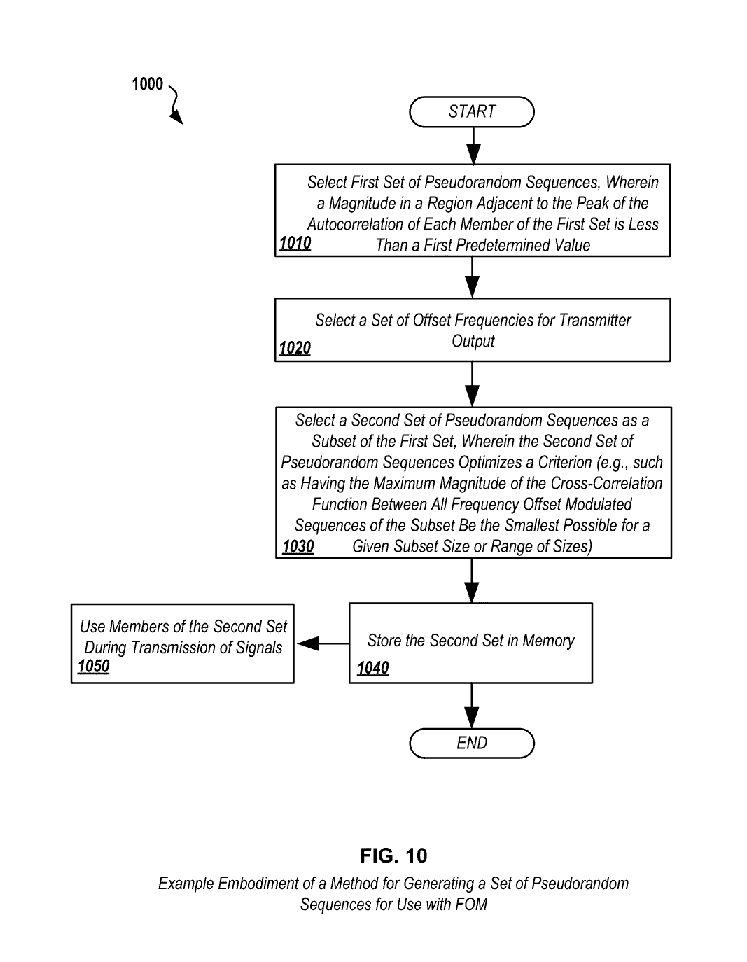

FIG. 10 illustrates details of an embodiment 1000 of a process for determining or generating a set of pseudorandom sequences for use in a WAPS system, such as for encoding at least a portion of a transmitted positioning signal. At stage 1010, a first set of pseudorandom sequences may be selected such as described previously herein. For example, the first set of pseudorandom sequences may be selected such that the magnitude of the autocorrelation function, in a region adjacent to the peak, of each member of the set is less than a predetermined value or threshold. At stage 1020 a set of offset frequencies, for use in generating transmitter outputs offset from a reference frequency, may be selected. At stage 1030, a second set of pseudorandom sequences may be selected in accordance with a performance criterion as a subset of the first set. For example, the second set may be selected such that the maximum magnitude of the cross-correlation function between all pairs of members of the second set, modulated by offset carriers, is the smallest possible for a given subset size at all frequencies of a set of offset frequencies. Selecting the second set this way may be used to minimize the value of cross-talk in a receiver during matched filter or correlation processing, such as described previously herein. At stage 1040, the second set of pseudorandom codes may be stored in a memory. The memory may be in a server system or other electronic device or system, or may be in a transmitter in a WAPS such as shown in FIG. 1. If the memory is in a server or other system, the second set of pseudorandom codes may be provided, at stage 1050, to one or more transmitters of a WAPS system for use in encoding transmitted positioning signals. The method for code storage is typically based upon the specification of linear feedback shift registers; however, many alternatives exist, such as indices of a code set, relative delays between codes, and even a listing of each constituent element (e.g. bits or words) of the code sequences.

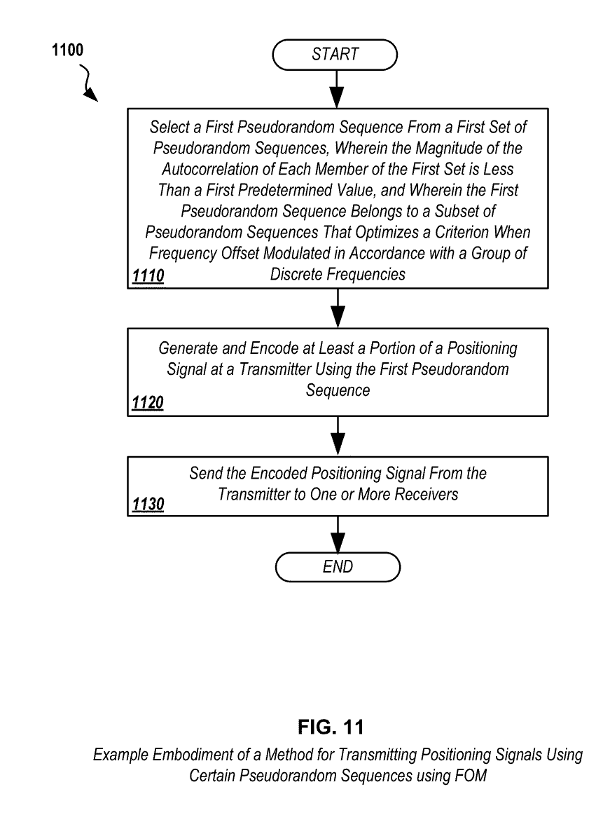

FIG. 11 illustrates details of an embodiment 1100 of a process for sending a positioning signal in a WAPS transmitter, such as one of the transmitters 110 of FIG. 1, with the positioning signal encoding at least in part using a pseudorandom code from a set of pseudorandom codes as described herein. At stage 1110, a pseudorandom sequence may be selected from the set of pseudorandom sequences. The set of pseudorandom sequences may be a set as described previously with respect to FIG. 10, such as all members of the set have a magnitude of their autocorrelation function (except at the peak) less than a predefined value. In addition, all members of the set may optimize a criterion, such as where the cross-correlation magnitude between set members at all offset frequencies, within a set of offset frequencies, is less than that of other sets of similar size. The pseudorandom sequence may be selected in a WAPS transmitter or provided to the WAPS transmitter from another system, such as the server system 130 as shown in FIG. 1. At stage 1120, a positioning signal may be generated in a WAPS transmitter. At least a portion of the positioning signal may be encoded using the selected pseudorandom sequence. At stage 1130, the generated positioning signal may be sent or broadcast from the WAPS transmitter and may then be received at one or more WAPS receivers. The WAPS receivers may have the pseudorandom sequence or set of sequences stored in a memory for use in demodulating and/or decoding the received positioning signal. In a typical embodiment, multiple positioning signals, using two or more different pseudorandom sequences from the set of pseudorandom sequences, may be sent from different WAPS transmitters to the WAPS receiver. In addition, the different WAPS transmitters my use the same or different offset frequencies.

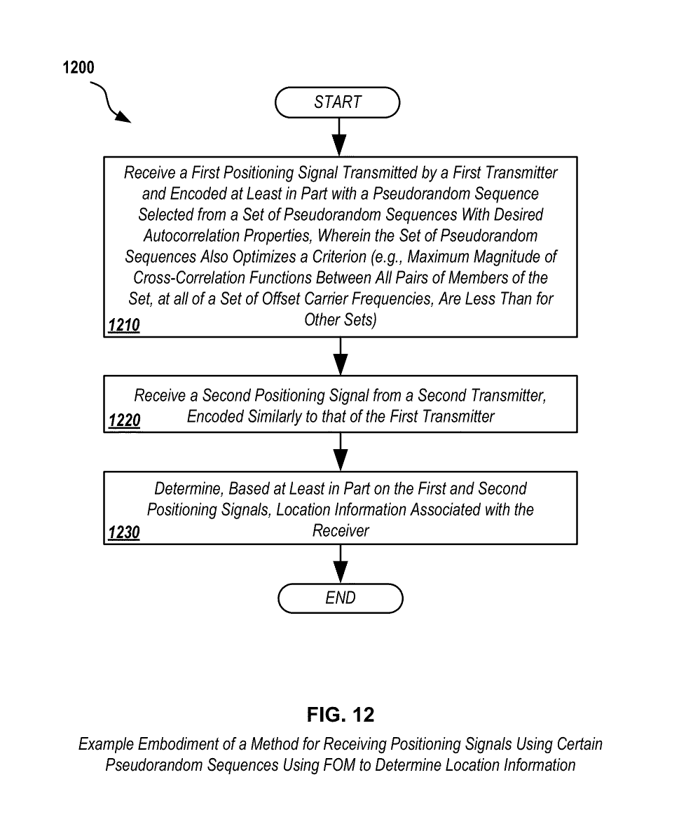

FIG. 12 illustrates details of an embodiment 1200 of a process for receiving positioning signals in a WAPS receiver, such as user device 120 of FIG. 1, or another integrated or standalone receiver device, using FOM, and using certain pseudorandom codes as described herein. At stage 1210, a first positioning signal from a first WAPS transmitter may be encoded at least in part using a pseudorandom sequence selected from a set of pseudorandom sequences with desired autocorrelation properties and that optimizes another performance criterion involving the relationship of the sequences to one another and a set of offset carrier frequencies. For example, the criterion may include having magnitudes of cross-correlation functions between all pairs of members of the set less than that of other other sets at all of a plurality of offset frequencies. At stage 1220, a second positioning signal, from a second WAPS transmitter, may be received at the WAPS receiver. The second positioning signal may be encoded with a second pseudorandom sequence chosen in a manner similar to that of the first positioning signal. At stage 1230, at the WAPS receiver, the received first positioning signal and the received second positioning signal may be processed, such as described in the incorporated applications, to determine location information associated with a location of the WAPS receiver.

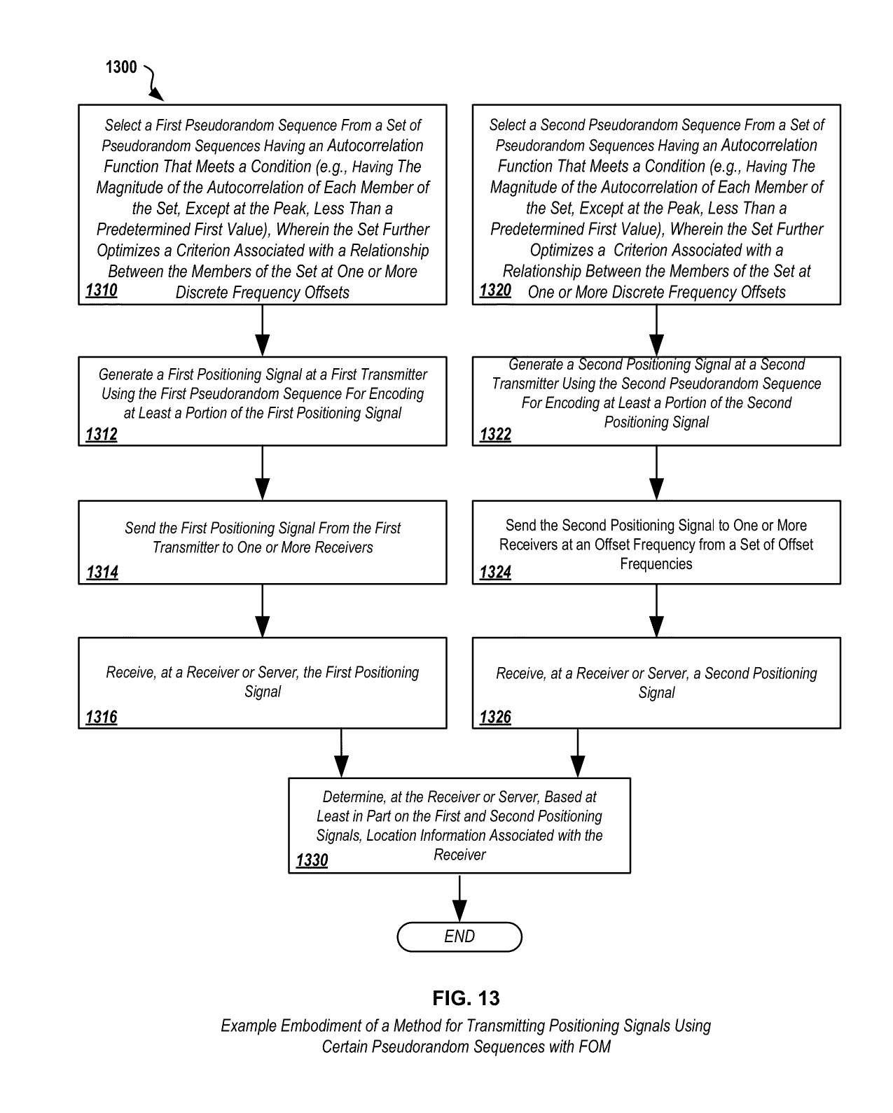

FIG. 13 illustrates details of an embodiment of a process 1300 for transmitting positioning signals in a WAPS system, using FOM, from two (or more) transmitters and receiving and processing the signals to determine location information at a corresponding WAPS receiver. Stages 1310 through 1314 represent stages in a first WAPS transmitter, and stages 1320-1324 represent stages in a second WAPS transmitter. These stages may be implemented approximately simultaneously in both transmitters such that the signals from each are received at a corresponding WAPS receiver at times that differ mainly due to differences in the path lengths between transmitters and the receiver.

At stage 1310, a first pseudorandom sequence may be selected from a set of pseudorandom sequences, where members of the set of pseudorandom sequences all have autocorrelation functions less than a predetermined value (e.g., having a magnitude of the autocorrelation of each member of the set, except at the peak, less than a predetermined first value) and further meeting a performance criterion that includes a relationship between all members at all offset frequencies of a set of offset frequencies. Similarly, at stage 1320, a second pseudorandom sequence may be selected from the set of pseudorandom sequences in a similar manner to that of the first pseudorandom sequence. For example, the criterion may involve the maximum magnitude of the cross-correlation between the FOM modulated sequences. The first and second pseudorandom sequences may be selected well in advance of transmission of positioning signals, and may be generated in an external system, such as the server system shown in FIG. 1, and communicated to the first and second transmitters. Alternately, the first and second pseudorandom sequences may be generated in one or both of the transmitters, and/or may be communicated between the transmitters to coordinate transmit operation.

At stages 1312 and 1322, first and second positioning signals may be generated at the first and second WAPS transmitters, with the first and second positioning signals encoded at least in part using the corresponding first and second pseudorandom sequences. At stages 1314 and 1324, the first and second positioning signals may be sent or transmitted from the first and second WAPS transmitters, with one of the signals offset by an offset frequency from the set of offset frequencies. Both transmitted signals may be received at a corresponding WAPS receiver at stages 1316 and 1326. At stage 1330, at the WAPS receiver, location information associated with a location of the WAPS receiver may be determined based at least in part on the first and second positioning signals. The location information may be determined using, for example, signal processing techniques as described herein and in the incorporated applications.

### Additional Aspects

One or more aspects may relate to systems, methods, computer program products and means for selecting codes to be used within positioning signals sent from one or more transmitters. Such systems may include one or more components or means (e.g., at least one processor) that are operable to implement one or more method steps. Such computer program products may comprise a non-transitory computer usable medium having a computer readable program code embodied therein that is adapted to be executed to implement one or method steps. Such method steps may: identify a set of digital pseudorandom sequences, wherein a magnitude of an autocorrelation function of each member of the set of digital pseudorandom sequences, within a specified zonal region adjacent to a peak of the autocorrelation function, is equal to or less than a first prescribed value; identify a subset of digital pseudorandom sequences, from among two or more subsets of pseudorandom sequences in the set of pseudorandom sequences, that optimizes a performance criterion, wherein the performance criterion is associated with a relationship between members within any subset of the two or more subsets.

In accordance with some aspects, the subset that optimizes the performance criterion minimizes a maximum magnitude of a cross-correlation between each pair of non-identical pseudorandom sequences of that subset. In accordance with some aspects, the first prescribed value is equal to or less than one-half of the maximum magnitude of the cross-correlation. In accordance with some aspects, the first prescribed value is equal to or less than one-tenth of the maximum magnitude of the cross-correlation.

In accordance with some aspects, a set of frequency offset modulated (FOM) signals is generated, where the members of the set of FOM signals are generated by modulating a carrier frequency signal with a member of the set of digital pseudorandom sequences, and where an offset frequency for the FOM signals is chosen among a predefined set of offset frequencies.

In accordance with some aspects, the performance criterion includes a minimization of the maximum magnitude of the cross-correlation between all pairs of FOM signals, where each pair has different pseudorandom sequences and where frequency offsets associated with each pair are within a specified range.

In accordance with some aspects, the first prescribed value is equal to or less than one-half of the maximum magnitude of the cross-correlation between the FOM signals.

In accordance with some aspects, the first prescribed value is equal to or less than one-tenth of the maximum magnitude of the cross-correlation between said FOM signals.

Additional method steps may: identify a first pseudorandom sequence from the subset; encode at least a portion of a first positioning signal using the identified first pseudorandom sequence; and cause the first positioning signal to be sent from a first transmitter.

Additional method steps may: identify a second pseudorandom sequence from the subset; encode at least a portion of a second positioning signal using the identified second pseudorandom sequence; and cause the second positioning signal to be sent from a second transmitter.

In accordance with some aspects, the second positioning signal is transmitted at an offset frequency relative to the first positioning signal.

In accordance with some aspects, the first pseudorandom sequence is selected at the first transmitter, and where the second pseudorandom sequence is selected at the second transmitter.

In accordance with some aspects, the first pseudorandom sequence and the second pseudorandom sequence are selected at a remote server system.

Additional method steps may: cause a receiver to determine location information using the first positioning signal and the second positioning signal.

Additional method steps may include: receive, at the receiver, the first and second positioning signals; and determine, based at least in part on the first and second positioning signals, information associated with a location of the receiver.

In accordance with some aspects, the information associated with the location of the receiver is further determined in part based on one or more received global navigation satellite system (GNSS) signals.

In accordance with some aspects, each subset of the plurality of subsets contain an equal number of pseudorandom sequences.

In accordance with some aspects, each subset of the plurality of subsets include respective numbers of pseudorandom sequences that are within a range of sizes.

Additional method steps may include: receive, at a first processor, data associated with the first and second positioning signals; and determine, based at least in part on the data associated with the first and second positioning signals, an estimated location of the receiver.

In accordance with some aspects, the performance criterion is optimized when the magnitude of the cross-correlation function between members of the subset, when modulated at each of one or more offset frequencies, is less than cross-correlation magnitudes of other subsets in the set.

In accordance with some aspects, the subset optimizes the performance criterion when a cross-correlation condition associated with the subset pseudorandom sequences is preferred over the cross-correlation condition associated with another subset of pseudorandom sequences.

In accordance with some aspects, the subset optimizes the performance criterion when a cross-correlation magnitude associated with the subset of pseudorandom sequences is less than a cross-correlation magnitude associated with the other subset of pseudorandom sequences.

In accordance with some aspects, the subset optimizes the performance criterion when a result achieved by pseudorandom sequences within the subset in relation to the performance criterion is preferred over another result achieved by pseudorandom sequences within another subset in relation to the performance criterion.

Other method steps may include: identify a first pseudorandom sequence from a subset of pseudorandom sequences within a set of pseudorandom sequences, wherein a magnitude of an autocorrelation function of each member of the set of pseudorandom sequences, within a zonal region adjacent to a peak of the autocorrelation function, meets a threshold condition, and wherein the subset optimizes a performance criterion between its members compared to other subsets of the set.

In accordance with some aspects, the subset that optimizes the performance criterion minimizes a maximum magnitude of a cross-correlation between pairs of members of that subset. In accordance with some aspects, the subset that optimizes the performance criterion minimizes a maximum magnitude of a cross-correlation between each pair of non-identical pseudorandom sequences of that subset, a set of frequency offset modulated (FOM) signals is generated, the members of the set of FOM signals are generated by modulating a carrier frequency signal with a member of the set of digital pseudorandom sequences, an offset frequency for the FOM signals is chosen among a predefined set of offset frequencies, and the performance criterion includes a minimization of the maximum magnitude of the cross-correlation between all pairs of FOM signals, where each pair has different pseudorandom sequences and wherein frequency offsets associated with each pair are within a specified range.

Additional method steps may: identify a first pseudorandom sequence from the subset; encode at least a portion of a first positioning signal using the identified first pseudorandom sequence; cause the first positioning signal to be sent from a first transmitter; identify a second pseudorandom sequence from the subset; encode at least a portion of a second positioning signal using the identified second pseudorandom sequence; and cause the second positioning signal to be sent from a second transmitter, where the second positioning signal is transmitted at an offset frequency relative to the first positioning signal, and where the subset optimizes the performance criterion when a cross-correlation condition associated with the subset pseudorandom sequences is preferred over the cross-correlation condition associated with another subset of pseudorandom sequences.

Other method steps may: receive a first positioning signal that is encoded at least in part with a first pseudorandom sequence selected from a subset of a set of pseudorandom sequences, wherein the set of pseudorandom sequences are characterized by having a magnitude of an autocorrelation function of each member of the set, within a specified zonal region adjacent to a peak of the autocorrelation function, equal to or less than a first prescribed value, and wherein the subset is selected from among a group of subsets to optimize a performance criterion in comparison to the other subsets of the group, wherein the performance criterion is associated with a relationship between members of any subset; receive a second positioning signal that is encoded at least in part with a second pseudorandom sequence from the subset of pseudorandom sequences; and determine, based at least in part on the first and second positioning signals, location information associated with a receiver.

In accordance with some aspects, the second positioning signal is sent at an offset frequency relative to the first positioning signal, wherein the offset frequency is selected from a set of one or more predefined offset frequencies. In accordance with some aspects, each subset of the group of subsets has a number of pseudorandom sequences that falls within a specified range of numbers. In accordance with some aspects, the location information is determined further based at least in part on a received GNSS signal. In accordance with some aspects, the subset that the optimizes the performance criterion minimizes a magnitude of a cross-correlation between pairs of members of that subset.

In accordance with some aspects, a set of frequency offset modulated (FOM) signals is generated, where the members of the set of FOM signals are generated by modulating a carrier frequency signal with a member of the set of digital pseudorandom sequences, where an offset frequency for the FOM signals is chosen among a predefined set of offset frequencies, where the performance criterion includes a minimization of the maximum magnitude of the cross-correlation between all pairs of FOM signals, where each pair has different pseudorandom sequences and wherein frequency offsets associated with each pair are within a specified range, and where the subset optimizes the performance criterion when a cross-correlation condition associated with the subset pseudorandom sequences is preferred over the cross-correlation condition associated with another subset of pseudorandom sequences.

Additional method steps may: identify a first pseudorandom sequence from the subset; encode at least a portion of a first positioning signal using the identified first pseudorandom sequence; cause the first positioning signal to be sent from a first transmitter; identify a second pseudorandom sequence from the subset; encode at least a portion of a second positioning signal using the identified second pseudorandom sequence; and cause the second positioning signal to be sent from a second transmitter, where the subset that optimizes the performance criterion minimizes a maximum magnitude of a cross-correlation between each pair of non-identical pseudorandom sequences of that subset.

Other method steps may: encode at least a portion of a first positioning signal using a first code; encode at least a portion of a second positioning signal using a second code; cause the encoded first positioning signal to be sent from a first transmitter; and cause the encoded second positioning signal to be sent from the second transmitter, where the first and second codes are included among members of a first set of codes that optimize a performance criterion associated with a relationship between the members of the first set of codes, and where the first and second codes are included among members of a second set of codes characterized by having a magnitude of an autocorrelation function within a zonal region adjacent to a peak of the autocorrelation function that is equal to or less than a first prescribed value. In accordance with some aspects, the second positioning signal is sent from the second transmitter at an offset frequency relative to the first positioning signal. In accordance with other aspects, the offset frequency is selected from a predefined set of offset frequencies.

Although certain embodiments describe subsets of codes from a set of codes, it is contemplated that codes may belong to two sets that are not necessarily related to each other beyond including one or more shared codes. Additionally, it is contemplated that the auto and cross correlation analyses may occur in a different order (e.g., choosing a set of codes with good cross-correlation properties and then optimizing to get a subset of those codes with good autocorrelation properties). Also, it is contemplated that the auto and cross correlation analyses may occur independent of one another, and codes are selected from an intersection of codes that are determined from each analysis.

Systems may include any or all of: one or more receivers at which position information is received and used to compute a position of the respective receiver; one or more servers at which position information is received and used to compute a position of a receiver; both receivers and servers; or other components.

### Other Aspects

Systems and methods described herein may track the position computing devices or other things to provide position information and navigation with or to such devices and things. It is noted that the term “GPS” may refer any Global Navigation Satellite Systems (GNSS), such as GLONASS, Galileo, and Compass/Beidou. Transmitters may transmit positioning data in a signal received by a user device. Positioning data may include “timing data” that can be used to determine propagation time of a signal (e.g., time-of-arrival (TOA)), which can be used to estimate a distance between a user device and transmitter (e.g., pseudorange) by multiplying the propagation time of the signal by the speed of the signal.

The various illustrative systems, methods, logical features, blocks, modules, components, circuits, and algorithm steps described herein may be implemented, performed, or otherwise controlled by suitable hardware known or later developed in the art, or by software executed by a processor (also referred to as a “processing device” and also inclusive of any number of processors), or by both. A processor may perform or cause any of the processing, computational, method steps, or other system functionality relating to the processes/methodologies and systems disclosed herein, including analysis, manipulation, conversion or creation of data, or other operations on data. A processor may include a general purpose processor, a digital signal processor (DSP), an application specific integrated circuit (ASIC), a field programmable gate array (FPGA) or other programmable logic device, discrete gate or transistor logic, discrete hardware components, server, or any combination thereof. A processor may be a conventional processor, microprocessor, controller, microcontroller, or state machine. A processor can also refer to a chip, where that chip includes various components (e.g., a microprocessor and other components). The term “processor” may refer to one, two or more processors of the same or different types. It is noted that the terms “computer” or “computing device” or “user device” or the like may refer to devices that include a processor, or may refer to the processor itself. Software may reside in RAM memory, flash memory, ROM memory, EPROM memory, EEPROM memory, registers, hard disk, a removable disk, a CD-ROM, or any other form of storage medium. A “memory” may be coupled to a processor such that the processor can read information from and write information to the memory. The storage medium may be integral to the processor. Software may be stored on or encoded as one or more instructions or code on a computer-readable medium. Computer-readable media be any available storage media, including non-volatile media (e.g., optical, magnetic, semiconductor) and carrier waves that transfer data and instructions through wireless, optical, or wired signaling media over a network using network transfer protocols. Aspects of systems and methods described herein may be implemented as functionality programmed into any of a variety of circuitry, including. Aspects may be embodied in processors having software-based circuit emulation, discrete logic, custom devices, neural logic, quantum devices, PLDs, FPGA, PAL, ASIC, MOSFET, CMOS, ECL, polymer technologies, mixed analog and digital, and hybrids thereof. Data, instructions, commands, information, signals, bits, symbols, and chips that may be referenced throughout the above description may be represented by voltages, currents, electromagnetic waves, magnetic fields or particles, optical fields or particles, or any combination thereof. Computing networks may be used to carry out aspects and may include hardware components (servers, monitors, I/O, network connection). Application programs may carry out aspects by receiving, converting, processing, storing, retrieving, transferring and/or exporting data, which may be stored in a hierarchical, network, relational, non-relational, object-oriented, or other data source. “Data” and “information” may be used interchangeably. The words “comprise,” “comprising,” “include,” “including” and the like are to be construed in an inclusive sense (i.e., not limited to) as opposed to an exclusive sense (i.e., consisting only of). Words using the singular or plural number also include the plural or singular number respectively. The words “or” or “and” cover any of the items and all of the items in a list. “Some” and “any” and “at least one” refers to one or more. The term “device” may comprise one or more components (e.g., a processor, a memory, a screen). The terms “module,” “block,” “feature,” or “component” may refer to hardware or software, or a combination of both hardware and software, that is configured to carry out or otherwise achieve the functionality associated with those modules, blocks, features or components. Similarly, features in system and apparatus figures that are illustrated as rectangles may refer to hardware or software. It is noted that lines linking two such features may be illustrative of data transfer between those features. Such transfer may occur directly between those features or through intermediate features even if not illustrated. Where no line connects two features, transfer of data between those features is contemplated unless otherwise stated. Accordingly, the lines are provide to illustrate certain aspects, but should not be interpreted as limiting.

The inventive concepts herein illustrated in the context of wide area positioning systems, but may also be applied to other positioning systems, such as in building location systems or other systems. When referring to position location systems, it is also understood herein that this includes distance measurement, or the measurement of the time-of-arrival of a signal, when such a time-of-arrival is used in some type of position location calculation. It is also noted that the methods described herein may be applied to both forward and inverse positioning systems as well as to round trip time measurement systems or other systems using signal propagation times for distance measurement.

The various components, modules, and functions described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

The disclosure is not intended to be limited to the aspects shown herein but is to be accorded the widest scope understood by a skilled artisan, including equivalent systems and methods. The protection afforded the present invention should only be limited in accordance with the following claims.

We claim:

1. A system for selecting codes to be used within positioning signals sent from one or more transmitters, the system comprising at least one processor operable to:
identify a set of digital pseudorandom sequences, wherein a magnitude of an autocorrelation function of each member of the set of digital pseudorandom sequences, within a specified zonal region adjacent to a peak of the autocorrelation function, is equal to or less than a first prescribed value; and
identify a subset of digital pseudorandom sequences, from among two or more subsets of pseudorandom sequences in the set of pseudorandom sequences, that optimizes a performance criterion, wherein the performance criterion is associated with a relationship between members within any subset of the two or more subsets.

2. The system of claim 1, wherein the subset that optimizes the performance criterion minimizes a maximum magnitude of a cross-correlation between each pair of non-identical pseudorandom sequences of that subset.

3. The system of claim 2, wherein the first prescribed value is equal to or less than one-half of the maximum magnitude of the cross-correlation.

4. The system of claim 2, wherein said first prescribed value is equal to or less than one-tenth of the maximum magnitude of the cross-correlation.

5. The system of claim 1, wherein a set of frequency offset modulated (FOM) signals is generated, wherein the members of the set of FOM signals are generated by modulating a carrier frequency signal with a member of the set of digital pseudorandom sequences, and wherein an offset frequency for the FOM signals is chosen among a predefined set of offset frequencies.

6. The system of claim 5, wherein the performance criterion includes a minimization of the maximum magnitude of the cross-correlation between all pairs of FOM signals, wherein each pair has different pseudorandom sequences and wherein frequency offsets associated with each pair are within a specified range.

7. The system of claim 6, wherein the first prescribed value is equal to or less than one-half of the maximum magnitude of the cross-correlation between the FOM signals.

8. The system of claim 6, wherein the first prescribed value is equal to or less than one-tenth of the maximum magnitude of the cross-correlation between said FOM signals.

9. The system of claim 1, wherein the at least one processor is further operable to:
identify a first pseudorandom sequence from the subset;
encode at least a portion of a first positioning signal using the identified first pseudorandom sequence; and
cause the first positioning signal to be sent from a first transmitter.

10. The system of claim 9, wherein the at least one processor is further operable to:
identify a second pseudorandom sequence from the subset;
encode at least a portion of a second positioning signal using the identified second pseudorandom sequence; and
cause the second positioning signal to be sent from a second transmitter.

11. The system of claim 10, wherein the second positioning signal is transmitted at an offset frequency relative to the first positioning signal.

12. The system of claim 10, wherein the first pseudorandom sequence is selected at the first transmitter, and wherein the second pseudorandom sequence is selected at the second transmitter.

13. The system of claim 10, wherein the first pseudorandom sequence and the second pseudorandom sequence are selected at a remote server system.

14. The system of claim 10, wherein the at least one processor is further operable to:
cause a receiver to determine location information using the first positioning signal and the second positioning signal.

15. The system of claim 14, wherein the at least one processor is further operable to:
receive, at the receiver, the first and second positioning signals; and
determine, based at least in part on the first and second positioning signals, information associated with a location of the receiver.

16. The system of claim 15, wherein the information associated with the location of the receiver is further determined in part based on one or more received global navigation satellite system (GNSS) signals.

17. The system of claim 1, wherein each subset of the two or more subsets contain an equal number of pseudorandom sequences.

18. The system of claim 1, wherein each subset of the two or more subsets include respective numbers of pseudorandom sequences that are within a range of sizes.

19. The system of claim 10, wherein the at least one processor is further operable to:
receive, at a first processor, data associated with the first and second positioning signals; and
determine, based at least in part on the data associated with the first and second positioning signals, an estimated location of the receiver.

20. The system of claim 1, wherein the performance criterion is optimized when the magnitude of the cross-correlation function between members of the subset, when modulated at each of one or more offset frequencies, is less than cross-correlation magnitudes of other subsets in the set.

21. The system of claim 1, wherein the subset optimizes the performance criterion when a cross-correlation condition associated with the subset pseudorandom sequences is preferred over the cross-correlation condition associated with another subset of pseudorandom sequences.

22. The system of claim 21, wherein the subset optimizes the performance criterion when a cross-correlation magnitude associated with the subset of pseudorandom sequences is less than a cross-correlation magnitude associated with the other subset of pseudorandom sequences.

23. The system of claim 1, wherein the subset optimizes the performance criterion when a result achieved by pseudorandom sequences within the subset in relation to the performance criterion is preferred over another result achieved by pseudorandom sequences within another subset in relation to the performance criterion.
